(19) United States
(12) Patent Application Publication
(10) Pub. No.: US 2015/0130281 A1
(43) Pub. Date: May 14, 2015

(54) Integrated Energy Module

(71) Applicant: S. Shey Sabripour, Austin, TX (US)

(72) Inventor: S. Shey Sabripour, Austin, TX (US)

(21) Appl. No.: 14/076,259

(22) Filed: Nov. 10, 2013

(51) Int. Cl. H01M 10/46; H02J 7/00; H02J 1/14

(52) U.S. Cl. CPC H01M 10/465; H02J 1/14; H02J 7/0052; H02J 7/007
USPC 307/66

(57) ABSTRACT

An integrated energy module includes an array of photovoltaic cells, a battery module, and an input/output interface. The integrated energy module further includes an integrated power control circuit to configure the input/output interface to dynamically couple to one or more other integrated energy modules of a solar array.

### FIELD

The present disclosure is generally related to photovoltaic energy generation systems, and more particularly to an integrated energy module that includes energy generation and storage.

### BACKGROUND

Solar energy represents a potentially limitless renewable energy source. Unfortunately, devices that harvest solar energy are costly and, as low density energy collectors, take up a large foot print on an area of real estate.

### SUMMARY

In an embodiment, an integrated energy module includes an array of photovoltaic cells, a battery module, and an input/output interface. The integrated energy module further includes an integrated power control circuit to configure the input/output interface to dynamically couple to one or more other integrated energy modules of a solar array.

In another embodiment, a power generation system includes a solar array formed from a plurality of integrated energy modules. Each of the plurality of integrated energy modules includes a housing, at least one photovoltaic cell within the housing, a battery module within the housing, and an input/output interface at least partially within the housing. Each of the plurality of integrated energy modules further includes an integrated power control circuit within the housing. The integrated power control circuit configures the input/output interface to dynamically interconnect the integrated energy module to one or more other integrated energy modules of the solar array.

In still another embodiment, an integrated energy module includes a housing, an array of photovoltaic cells within the housing, and a battery module within the housing. The integrated energy module further includes an integrated power control circuit within the housing. The integrated energy module is configured to selectively activate one or more switches to recover energy from at least a portion of one of the photovoltaic cells of the array.

### BRIEF DESCRIPTION OF THE DRAWINGS

FIG. 1 is a diagram of a solar power system including an integrated energy module implemented as a car port according to an embodiment.

FIG. 2 is a block diagram of a solar power system including an integrated energy module implemented as a rooftop solar panel according to a second embodiment.

FIG. 3 is a block diagram of solar panel including multiple integrated energy modules according to an embodiment.

FIG. 4 is a diagram of an integrated energy module including multiple photovoltaic cells according to an embodiment.

FIG. 5 is a block diagram of an integrated energy module according to an embodiment.

FIG. 6 is a block diagram of the circuitry of an integrated energy module according to an embodiment.

FIG. 7 is a partial circuit and partial block diagram of an integrated energy module according to an embodiment.

FIG. 8 is a circuit diagram of a portion of the integrated energy module of FIG. 7 according to an embodiment.

FIG. 9 is a diagram of a solar power system including multiple integrated energy modules according to an embodiment.

FIG. 10 is a block diagram of a solar power system including multiple integrated energy modules according to an embodiment.

FIG. 11 is a block diagram of a solar power system including integrated energy modules that can be selectively interconnected according to an embodiment.

FIG. 12 is a block diagram of a power management system of a solar power system according to an embodiment.

FIG. 13 is a flow diagram of a method of repairing an integrated energy module according to an embodiment.

In the following discussion, the same reference numbers are used in the various embodiments to indicate the same or similar elements.

### DETAILED DESCRIPTION OF ILLUSTRATIVE EMBODIMENTS

Embodiments of solar energy systems, methods and devices are described below that include multiple integrated energy modules. Each integrated energy module includes one or more photovoltaic (PV) cells, load balancing circuitry, a charge-discharge circuit, a bidirectional direct-current (DC) to DC converter, charge storage devices, and a bidirectional integrated DC to alternating current (AC) inverter and a housing sized to receive and secure such components. In a particular embodiment, the integrated energy module may be portable such that an individual may readily transport an integrated energy module by hand.

Further, the integrated energy modules include one or more power management and distribution (PMAD) digital signal controllers (DSCs) configured to control the load balancing circuitry, the charge-discharge circuit, the bidirectional DC-DC converter, and the bidirectional DC-AC inverter. Additionally, the one or more PMAD DSCs may be configured to selectively couple one integrated energy module to another within an array of integrated energy modules. In an embodiment, the integrated energy module is provided within a housing and includes one or more input/output (I/O) terminals configured to interconnect with I/O terminals of adjacent integrated energy modules to provide a modular plug-and-play-and-align energy module that can be coupled to other energy modules to produce a dynamically configurable energy generation system.

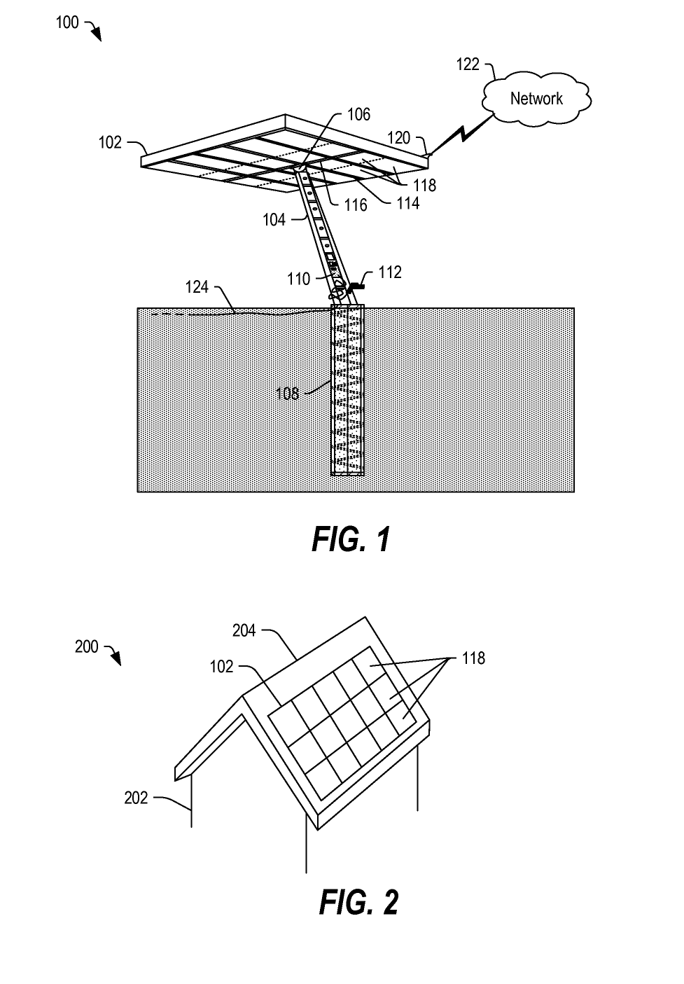

In an embodiment, each energy module may include a built-in test configured to verify one or more components. Further, one or more of the energy modules may include or be coupled to a communications circuit configured to communicate with remote systems through a communications network, such as a cellular, digital, or satellite network. Each energy module may also include adjust-bypass-control functionality to produce a self-regulated AC current injection signal to be used for a grid tie or off-grid applications. Further, each energy module includes an interface configured to communicate with other modules to provide a self-organizing, self-healing electronic interconnect network. The integrated battery makes the PV system into a building block energy storage and generation module, and the bidirectional DC-to-AC inverter includes phase synchronization electronics configured to provide an AC output that can be provided to the grid or to an AC load. The bidirectional DC-to-AC inverter makes it possible to also charge the integrated battery from power received from the grid, if the photovoltaic cells are not producing sufficient energy to charge the integrated battery. One possible example of a solar power system including an integrated energy module is described below with respect to FIG. 1.

FIG. 1 is a block diagram of a solar power system 100 including an integrated energy module 118 implemented as a car port according to an embodiment. Solar power system 100 includes a solar array 102 coupled to a pillar 104 by a tri-axially adjustable trunion 106. The pillar 104 is coupled to a support structure 108, which extends below ground.

The solar array 102 may be secured by a canopy that has a spine or (I-beam) 116 and a plurality of ribs 114, which are configured to support a plurality of integrated energy modules 118. The canopy may also support a communication device 120, such as an antenna, which may be coupled to one or more of the integrated energy modules 118 and which may communicate wirelessly with a network 122, such as a cellular, digital, satellite, or other wireless network.

Solar power system 100 may further include a power management system 110, which may include a user interface and a charge card interface. Solar power system 100 may also include a charger 112, which may be releasable coupled to a vehicle and configured to provide a DC charge to recharge batteries of the vehicle. In an embodiment, the user may purchase an electric charge by interacting with the power management system 110. Solar power system 100 may also provide an AC line 124, which may be coupled to a power grid through a meter or which may be coupled through a circuit panel to an AC load, such as a building or other structure.

Each integrated energy module 118 includes multiple photovoltaic (PV) cells, load balancing circuitry, a charge-discharge circuit, a direct-current (DC) to DC converter, charge storage devices (e.g., multiple batteries), and an integrated DC to alternating current (AC) inverter. Further, the integrated energy modules include one or more power management and distribution (PMAD) digital signal controllers (DSCs) configured to control the load balancing circuitry, the charge-discharge circuit, the DC-DC converter, and the DC-AC inverter. Additionally, the one or more PMAD DSCs may be configured to selectively couple one integrated energy module to another within an array of integrated energy modules.

The illustrated example of FIG. 1 represents one possible implementation of a solar array comprised of integrated energy modules. Other implementations are also possible. One possible implementation of a solar panel for use on the roof of a home is described below with respect to FIG. 2.

FIG. 2 is a block diagram of a solar power system 200 including an integrated energy module 118 implemented as a solar panel 102 mounted to a rooftop 204 of a house 202 according to a second embodiment. As discussed above, solar power system 200 includes multiple integrated energy modules 118, each of which includes multiple solar cells, a load balancing circuit, a charge-discharge circuit, a charge storage device (e.g., batteries), a DC-to-DC converter, and a DC-AC converter. The DC-AC converter may be coupled to a circuit breaker panel or box within the house 202 to provide AC power, and optionally to provide power to the power grid through a meter.

In the examples of FIGS. 1 and 2, the integrated energy modules provide energy storage, making it possible to convert stored energy into an AC current as needed to supply power to the household when the power grid is down. In a particular example, integrated energy modules may include a power controller configured to communicate with a master switch to selectively disconnect the circuit panel from the power grid in response to a power outage and to enable delivery of AC power to the household from the stored battery charges. When power from the grid is restored, the controller may control the master switch to selectively couple the circuit panel to the power grid. In another example, if the solar power system 202 or the solar array 102 are shaded or not functioning, the bidirectional DC-to-AC converter may direct power from the grid to a battery charge/recharge circuit to charge the batteries.

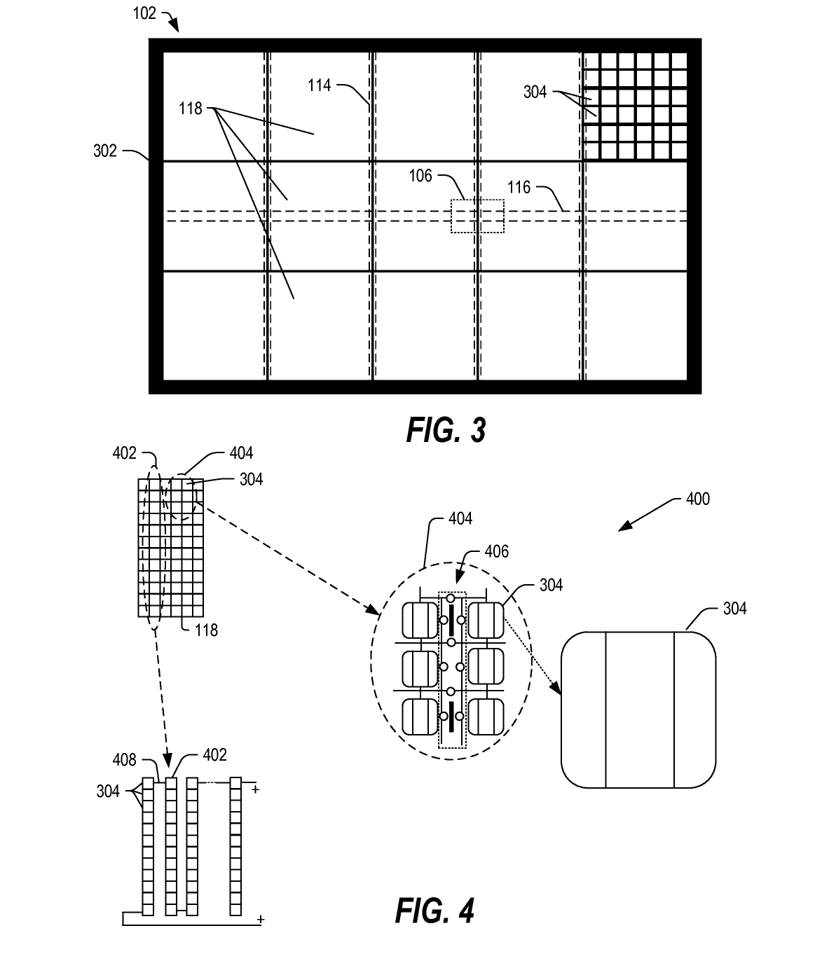

In the illustrated examples, the solar panels 102 have been depicted with fifteen integrated power modules 118. However, any number of integrated power modules 118 may be interconnected to form the solar array. Further, each integrated power module 118 may include any number of photovoltaic cells. One possible implementation of the solar panels 102 of FIGS. 1 and 2 is described below with respect to FIG. 3.

FIG. 3 is a block diagram of solar panel 102 including multiple integrated energy modules 118 according to an embodiment. Solar panel 102 includes a frame 302 coupled to spine 116 and ribs 114 (shown in phantom), which support the integrated energy modules 118. Further, trunion 106 is depicted in phantom, where it may couple to spine 116. In an embodiment, the frame may be formed from a polyvinylchloride (PVC) material or from a metal, such as aluminum.

Each integrated energy module 118 includes a plurality of photovoltaic (PV) cells 304. In an embodiment, the PV cells may be monocrystalline cells adapted to convert solar energy into electricity. In the illustrated example, the integrated energy module 118 includes 36 PV cells 304. However, any number of PV cells may be included in an integrated energy module 304. Within the integrated energy module 118, a load balancing circuit may be configured to balance the charge and a charge/discharge circuit may be configured to store charge in one or more batteries. In general, each integrated energy module 118 is configured to store charge, and the integrated energy modules are configured to communicate with one another so that, if batteries of one integrated energy module 118 fail, the charge produced by that particular integrated energy module 118 may be distributed to other batteries through a switch network controlled by the PMAD DSCs. In an embodiment, the load balancing circuit may include a maximum peak power detection circuit, and the load balancing circuitry (or the PMAD DSC) may configure one or more switches to recover power from at least portion of a solar cell. In an example, if a solar cell is partially shaded or damaged, the load balancing circuit can automatically and dynamically adjust its connections to recover maximum power from the solar cell. One possible example of the interconnecting network of PV cells within an integrated energy module 118 is described below with respect to FIG. 4.

FIG. 4 is a diagram 400 of an integrated energy module 118 including multiple PV cells 304 according to an embodiment. Integrated energy module 118 includes a solar array formed from multiple PV cells 304 arranged in rows and columns. Each PV cell 304 is configured to convert solar energy into electricity, which may be stored in batteries and/or converted into an AC current by integrated circuitry of the integrated energy module 118. In the illustrated example, the solar array includes seventy-two PV cells 304 arranged in six columns by twelve rows. Dashed oval 402 surrounds one column of PV cells.

In the illustrated example, the columns PV cells 402, such as the column encircled by oval 402, are arranged in series. In this configuration, the electricity generated by a first PV cell in the column is added to that of the second PV cell, then to the third PV cell, and so on. In a conventional solar array configuration, a bypass diode is provided between one column and the next such that, if one of the PV cells within a column fails, the column can be bypassed. However, the integrated energy module 118 includes circuitry that can provide peak power tracking and is configured to harvest a maximum amount of energy from a damaged, partially damaged, or partially shaded PV structure (cell, array of cells, etc.) to maximize the power output of the solar panel 102. In an embodiment, the circuitry may be configured to recover available energy from even a portion of a cell within the array by identifying a connection to the cell that provides a peak power output and by selectively routing that power to the next cell in the array.

In the illustrated example, dashed oval 404 encircles six PV cells of the solar array, including three PV cells in a first column and three PV cells in the adjacent column. The PV cells 304 are interconnected by integrated circuitry, generally indicated at 406. In this example, the integrated circuitry 406 includes switches (generally depicted as circles), which may be selectively enabled to interconnect the PV cells 304 dynamically and/or to selectively bypass a single failed PV cell or a group of PV cells. Instead of bypassing an entire column (such as 402), control circuitry is configured to enable selected switches to bypass only the failed PV cells, thereby enhancing the overall energy production of the solar array. In another embodiment, the control circuitry may be configured to bypass failed portions of a single PV cell to recover maximum available power from each solar cell and from the solar array. In this example, the granularity of the control circuitry allows for recovery of power even from PV cells that are broken, partially occluded, or even damaged.

As discussed above, each integrated energy module 118 includes integrated circuitry and batteries for energy storage. During operation, electricity production and energy storage may cause some heating, which can reduce the overall efficiency of the integrated circuitry 406. However, in an embodiment, a cooling fluid conduit may be provided that circulates from a base of the support structure 108, up the pillar 104 and into each of the integrated energy modules 118 to circulate a cooling fluid, maintaining a substantially constant temperature within the integrated energy modules 118.

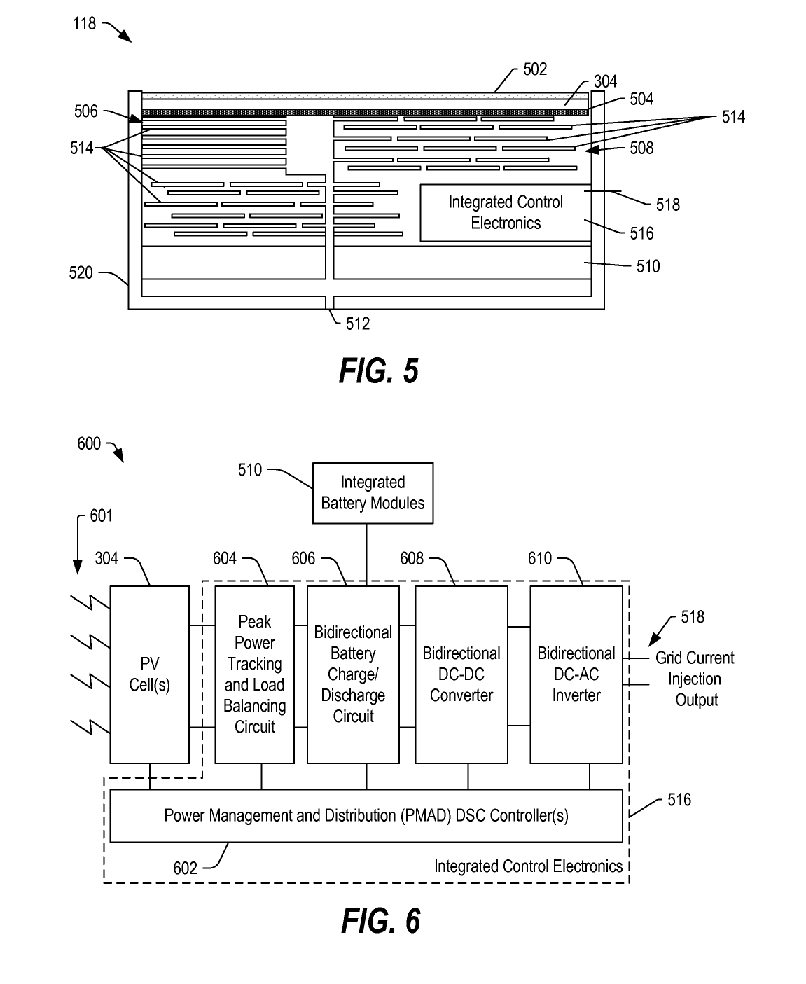

FIG. 5 is a block diagram of an integrated energy module 118 according to an embodiment. The integrated energy module 118 may include a protective cover layer 502, such as a Teflon® cover sheet (which may be commercially available from E.I. Du Pont De Nemours and Company of Wilmington, Del.), and includes photovoltaic generator, formed from a plurality of PV cells 304 and a back sheet 504. The integrated energy module 118 may also include integrated magnetics with ferrite layers (generally indicated at 506) and integrated capacitors with ceramic layers (generally indicated at 508). The integrated energy module 118 further includes integrated control electronics 516, including an interconnection bus 518, which may form at least a portion of a bus network structure that can be switchably interconnected to an adjacent integrated energy module 118. The integrated energy module 118 further includes integrated battery modules 510. In one embodiment, the integrated battery modules 510 may be lithium ion battery modules. The integrated energy module 118 may further include a cooling fluid conduit 512 that couples to a conduit within pillar 104 to receive a circulating fluid and that extends around the batteries and throughout the integrated energy module to cool the integrated energy module 118.

FIG. 6 is a block diagram of an integrated energy module 118 according to an embodiment. Integrated energy module 118 includes integrated control electronics 516, PV cells 304, and integrated battery modules 510. The PV cells 304 are configured to receive solar energy, generally indicated at 601, and to produce electricity in response to the solar energy. Integrated control electronics 516 are coupled to the PV cells 304.

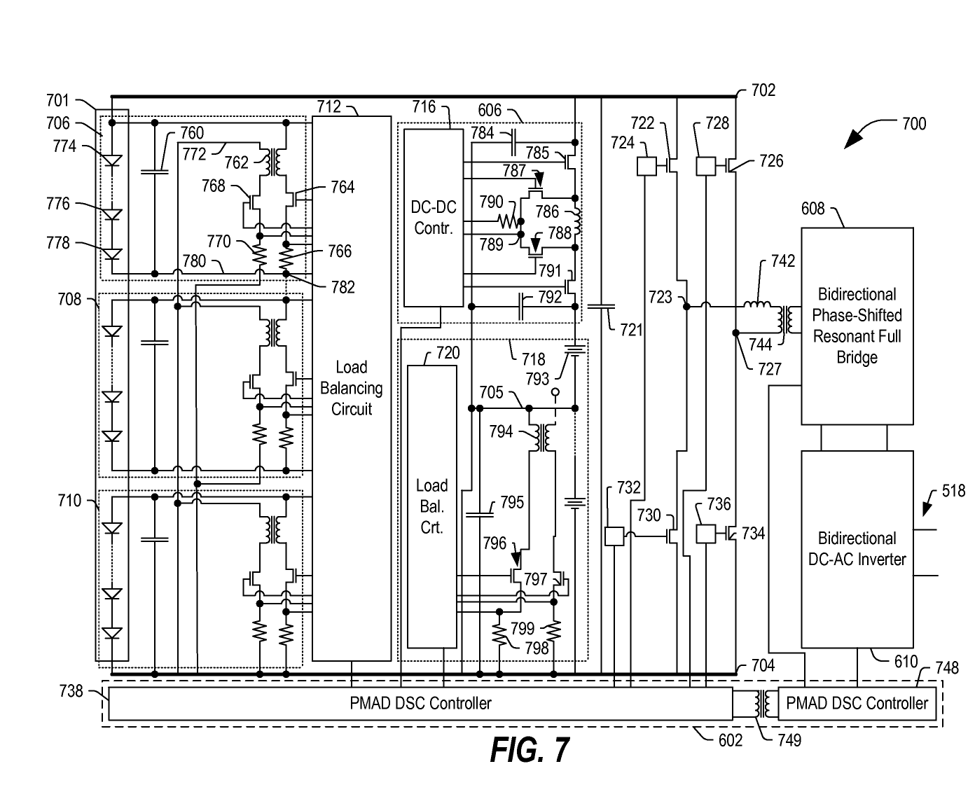

Integrated control electronics 516 include a peak power tracking and load balancing circuit 604 coupled to the PV cells 304 and to a battery charge/discharge circuit 606. In an embodiment, the peak power tracking and load balancing circuit 604 may include a maximum peak power tracking circuit. Battery charge/discharge circuit 606 is coupled to integrated battery modules 510 and to a bidirectional DC-to-DC converter 608. Bidirectional DC-to-DC converter 608 is coupled to bidirectional DC-to-AC inverter 610, which has an output configured to provide an AC current (labeled a “Current Injection Output”). Integrated energy module 118 further includes a power management and distribution (PMAD) digital signal controller (DSC) controller 602, which is coupled to the PV cells 304, the peak power tracking and load balancing circuit 604, the battery charge/discharge circuit 606, the bidirectional DC-to-DC converter 608, and the bidirectional DC-to-AC inverter 610. The bidirectional DC-to-AC inverter 610 is coupled to the interconnection bus 518, which can be used to provide a current injection output. One possible implementation of a circuit configured to implement the integrated energy module 118 is described below with respect to FIG. 7.

FIG. 7 is a partial circuit and partial block diagram of an integrated energy module 700 according to an embodiment. Integrated energy module 700 includes a first power node 702 and a second power node 704, an array of PV cells 701 coupled between the power nodes 702 and 704. The array of PV cells 701 and corresponding circuitry are depicted as grouped sub-units 706, 708, and 710. Within each sub-unit 706, 708, and 710, a number of PV cells are provided together with startup regulation circuitry. Each sub-unit 706, 708, and 710 is coupled to a load balancing circuit 712, which is coupled to node 702 and to PMAD DSC controller 602, which may include a first PMAD DSC controller 738 coupled to a second PMAD DSC controller 748 through a transformer 749. Integrated energy module 700 further includes bidirectional battery charge-discharge circuit 606 and a non-dissipative cell-balancer circuit 718.

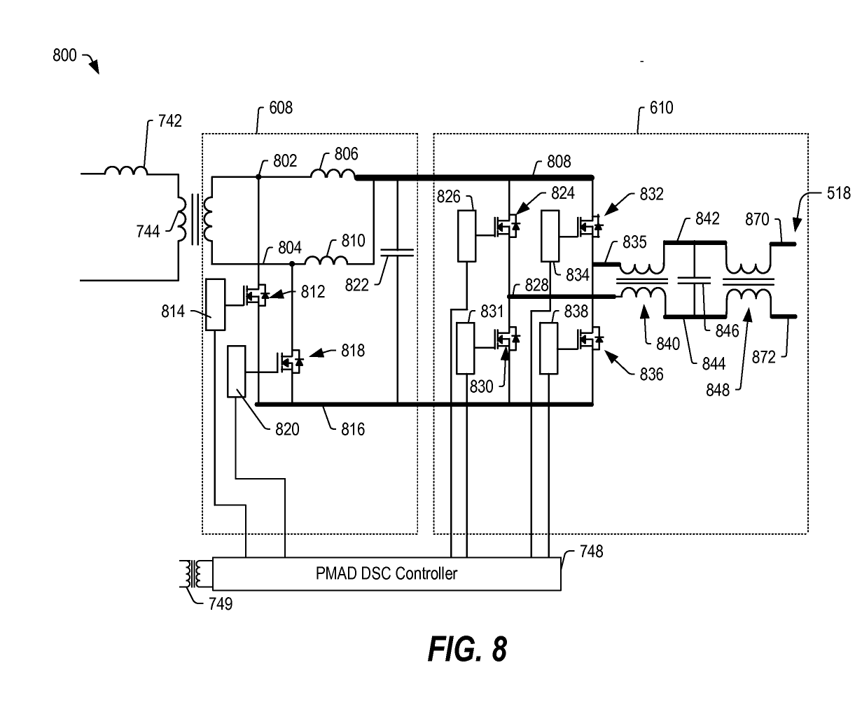

The integrated energy module 700 further includes a transistor 722 including a first terminal coupled to node 702, a control terminal coupled to driver circuit 724, and a second terminal coupled to a node 723. The driver circuit 724 is coupled to PMAD DSC controller 738. The integrated energy module 700 also includes a transistor 730 including a first terminal coupled to the node 723, a control terminal coupled to a driver circuit 732, and a second terminal coupled to node 704. The driver circuit 732 is coupled to PMA DSC controller 738. The integrated energy module 700 further includes a transistor 726 including a first terminal coupled to the node 702, a control terminal coupled to a driver circuit 728, and a second terminal coupled to a node 727. The driver circuit 728 is coupled to PMAD DSC controller 738. The integrated energy module 700 also includes a transistor 734 including a first terminal coupled to the node 727, a control terminal coupled to a driver circuit 736, and a second terminal coupled to node 704. The driver circuit 736 is coupled to PMAD DSC controller 738. The integrated energy module 700 further includes an inductor 742 coupled between node 723 and a first node of a first winding of a transformer 744. First winding includes a second node coupled to the node 727. A second winding of the transformer 744 is coupled to a bidirectional phase-shifted resonant full bridge circuit 608 (depicted in FIGS. 6 and 8), which is coupled to bidirectional DC-to-AC inverter 610. DC-to-AC inverter 610 is coupled to interconnection bus 518. Bidirectional phase-shifted resonant full bridge 608 and bidirectional DC-to-AC inverter 610 are coupled to PMAD DSC controller 748.

Sub-unit 706 includes PV cells 774, 776, and 778, which are represented as diodes, coupled in series between node 702 and a node 782, which is coupled to the load balancing circuit 712. Sub-unit 706 further includes a capacitor 760 coupled between nodes 702 and 782. Additionally, sub-unit 706 includes a transformer 762 including a first winding coupled between a node 772 and a first terminal of a transistor 768, which has a control terminal coupled to the load balancing circuit 712, and a second terminal coupled to a resistor 770, which is coupled to the node 704. The transformer 762 includes a second winding coupled between node 702 and a first terminal of a transistor 764, which has a control terminal coupled to the load balancing circuit 712, and a second terminal coupled to a resistor 766, which is coupled to the node 782. Each of the sub-units 706, 708, and 710 are interconnected between nodes 702 and 704 and are coupled to load balancing circuit 712.

The bidirectional battery charge-discharge circuit 606 includes a DC-to-DC controller 716 coupled to PMAD DSC controller 738 and includes a capacitor 784 coupled between node 702 and node 704. Further, the bidirectional battery charge-discharge circuit 606 includes a transistor 785 including a first terminal coupled to node 702, a control terminal coupled to DC-to-DC controller 716, and a second terminal coupled to an inductor 786. The bidirectional battery charge-discharge circuit 606 also includes a transistor 787 including a first terminal coupled to the second terminal of transistor 785, a control terminal coupled to DC-to-DC controller 716, and a second terminal coupled to a node 789. The bidirectional battery charge-discharge circuit 606 further includes a resistor 790 coupled between the node 789 and the DC-to-DC controller 716. The bidirectional battery charge-discharge circuit 606 also includes a transistor 788 including a first terminal coupled to the inductor 786, a control terminal coupled to the DC-to-DC controller 716, and a second terminal coupled to the node 789. The bidirectional battery charge-discharge circuit 606 further includes a transistor 791 including a first terminal coupled to the inductor 786, a control terminal coupled to the DC-to-DC controller 716, and a second terminal coupled to the non-dissipative load balancing circuit 718. Additionally, the bidirectional battery charge-discharge circuit 606 includes a capacitor 792 coupled between the second terminal of the transistor 791 and the node 704.

The non-dissipative load balancing circuit 718 includes a load balancing circuit 720 coupled to PMAD DSC controller 738. The non-dissipative load balancing circuit 718 further includes a plurality of battery modules, represented at 793 as a plurality of DC sources arranged in series between the second terminal of transistor 791 and the node 704. It should be understood that the plurality of battery modules may be arranged in series, in parallel, or any combination thereof. The non-dissipative load balancing circuit 718 also includes a transformer 794 including a first winding coupled to a node 705, which is coupled to the node 704 through a capacitor 795. Further, the first winding of the transformer 794 is coupled to a first terminal of a transistor 796, which has a control terminal coupled to load balancing circuit 720, and a second terminal coupled the load balancing circuit 720. A resistor 798 is coupled between the second terminal of transistor 796 and the node 704. The transformer 794 includes a second winding having a first end that may be coupled to a next integrated energy module of an array. The second winding further includes a second end coupled to a first terminal of a transistor 797, which has a control terminal coupled to the load balancing circuit 720 and a second terminal coupled to node 704 through a resistor 799. The second terminal of transistor 797 is also coupled to the load balancing circuit 720.

In an embodiment, the resistors 798 and 799 operate as sense resistors to provide a differential voltage to load balancing circuit 720, which can be used to adjust the load by controlling transistors 796 and 797. Other transistors and additional circuitry may be included that may be coupled in series via the second winding of transformer 794 to balance the load across multiple strings of battery modules within a single integrated energy module 118. In an example, the sub-unit of PV cells 706 may include a corresponding set of battery modules, and the load may be balanced by non-dissipative load balancing circuit across that set of battery modules, and across each of the battery modules corresponding to other sub-units 708 and 710.

FIG. 8 is a circuit diagram of a portion 800 of the integrated energy module 700 of FIG. 7 according to an embodiment. The portion 800 expands on the bidirectional phase-shifted resonant full bridge 608 and the bidirectional DC-to-AC inverter 610 in FIGS. 6 and 7. The portion 800 includes inductor 742 and transformer 744. The second winding of transformer 744 is coupled between nodes 802 and 804 within the bidirectional phase-shifted resonant full bridge 608. The bidirectional phase-shifted resonant full bridge 608 includes an inductor 806 coupled between node 802 and node 808 and includes an inductor 804 coupled between node 804 and node 808. The bidirectional phase-shifted resonant full bridge 608 further includes a transistor 812 including a first terminal coupled to node 802, a control terminal coupled to a driver circuit 814, and a second terminal coupled to a node 816. The driver circuit 814 is coupled to PMAD DSC controller 748. The bidirectional phase-shifted resonant full bridge 608 also includes a transistor 818 including a first terminal coupled to the node 804, a control terminal coupled to a driver circuit 820, and a second terminal coupled to the node 816. The driver circuit 820 is coupled to PMAD DSC controller 748. The bidirectional phase-shifted resonant full bridge 608 also includes a capacitor 822 coupled between the node 808 and the node 816.

The bidirectional DC-to-AC inverter 610 includes a transistor 824 including a first terminal coupled to the node 808, a control terminal coupled to a driver circuit 826, and a second terminal coupled to a node 828. The driver circuit 826 is coupled to the PMAD DSC controller 748. The bidirectional DC-to-AC inverter 610 further includes a transistor 830 including a first terminal coupled to the node 828, a control terminal coupled to a driver circuit 831, and a second terminal coupled to the node 816. The bidirectional DC-to-AC inverter 610 includes a transistor 832 including a first terminal coupled to the node 808, a control terminal coupled to a driver circuit 834, and a second terminal coupled to a node 835. The driver circuit 834 is coupled to PMAD DSC controller 748. The bidirectional DC-to-AC inverter 610 includes a transistor 836 including a first terminal coupled to the node 835, a control terminal coupled to a driver circuit 838, and a second terminal coupled to the node 816. The driver circuit 838 is coupled to PMAD DSC controller 748.

The bidirectional DC-to-AC inverter 610 further includes a transformer including a first winding coupled between the node 835 and a node 842 and a second winding coupled between the node 828 and a node 844. The bidirectional DC-to-AC inverter 610 also includes a capacitor 846 coupled between the nodes 842 and 844. Additionally, the bidirectional DC-to-AC inverter 610 includes a transformer 848 including a first winding coupled between the node 842 and a node 870 and including a second winding coupled between the node 844 and a node 872. The nodes 870 and 872 may be part of and configured to deliver current to the interconnection bus 518.

It should be understood that, within integrated energy module 700 in FIGS. 7 and 8, the PMAD DSC controllers 738 and 748 cooperate to control the load balancing circuits 712 and 720, DC-to-DC controller 716, driver circuits 724, 728, 732, and 736, 814, 820, 826, 831, 834, and 838. Because the integrated energy module 700 (118) includes battery modules, the integrated energy module 700 is configured to both store power in the battery modules and provide current (AC current) and/or voltage to the interconnection bus 518, depending on the situation.

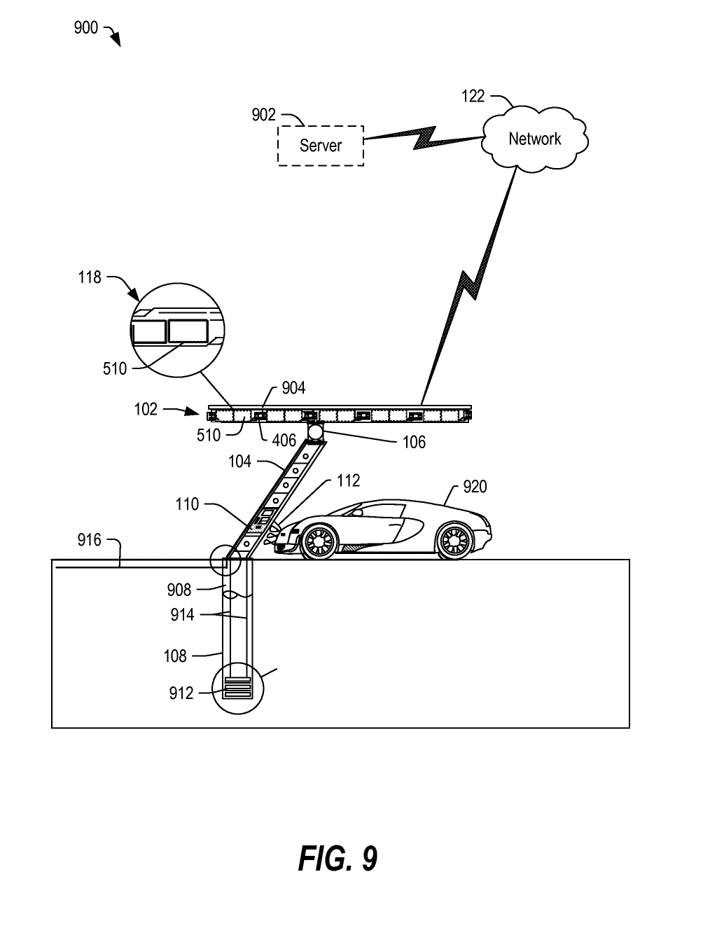

FIG. 9 is a diagram of a solar power system 900 including multiple integrated energy modules 118 according to an embodiment. The solar power system 900 provides an automotive charging system including a canopy configured to support a solar array 102 including a plurality of integrated energy modules 118. The solar power system 900 includes a protective cover 904 overlaying an array of integrated energy modules 118. Each of the integrated energy modules 118 includes a battery module 510 and integrated control circuitry 406, including the circuits of FIGS. 6-8 and switch circuitry.

The canopy is coupled to a pillar 104 by a trunion 106 that may be adjusted on three axes. The pillar 104 is coupled to a support structure 108, which extends below ground. A power management system and corresponding user interface may be coupled to the pillar 104 (as generally indicated at 110). The power management system 110 may communicate with a remote device (such as a remote server 902) through network 122. Alternatively, at least one of the integrated energy modules 118 may include a network transceiver configured to communicate wirelessly with server 902 through network 122.

Pillar 104 may include hollow portions configured to secure conduits for fluid flow as well as to secure electrical cables. Further, the hollow portions may house additional batteries and/or peak-demand supercapacitors. Pillar 104 may be coupled to a pre-cast concrete structure 108 by a mating structure 908. In an embodiment, a geothermal heat exchanger 912 is coupled to cooling conduits 512 (depicted in FIG. 5) within each of the integrated energy modules 118 through conduits 914, which extend through the hollow portions of pillar 104 to provide a coolant for circulation from the geothermal heat exchanger 912 to integrated energy modules 118. Further, integrated energy modules 118 within solar array 102 may be configured to provide an AC connector 916 for coupling to the power grid or to a nearby structure. AC connector 916 may be used to provide power from the solar array 102 to the power grid or the nearby structure or vice versa. Further, integrated energy modules 118 of solar array 102 may be configured to provide a high voltage DC charge to a load, such as electric car 920 through power management system 110. The power management system 110 may be configured to selectively allow supply of DC power to a DC charger for charging the electric car 920.

In an embodiment, the driver may reserve his/her recharge in advance by communicating with remote server 902. Once he/she arrives, he/she may interact with a user interface of the power management system 110 to log in and to activate the recharge operation. The user may then couple the DC charger 112 to his/her electric car 920 to initiate the recharge operation.

In another embodiment, the driver may interact with the user interface of power management system 110 to pay for the recharge and to activate the recharge operation, such as by swiping his/her credit card and selecting a type of charge (fast charge or normal charge). The user may then couple the DC charger 112 to his/her electric car 920 to initiate the recharge.

It should be appreciated that, though only one canopy and power management system 110 are shown, a recharge station may include a plurality of canopies and recharge systems. Further, it should be appreciated that, a particular power management system 110 may be configured to perform one or two fast recharge operations (which are high voltage and power operations that may fully recharge an electric car in less than half an hour) and may otherwise either be unable to recharge the vehicle or may only be able to recharge the vehicle over an extended period of time, such as eight hours. Thus, a particular charging station may include multiple power management systems 110 and may be configured to perform multiple fast recharges. Each power management system 110 may be configured to communicate through a wired or wireless connection to the other power management systems 110 in order to assist a customer to receive a desired level of service, such as by directing the driver to a different station to receive his/her desired recharge. Alternatively or in addition, each power management system 110 may provide a visible indicator of the charge status, allowing the user to drive up to the appropriate power management system 110.

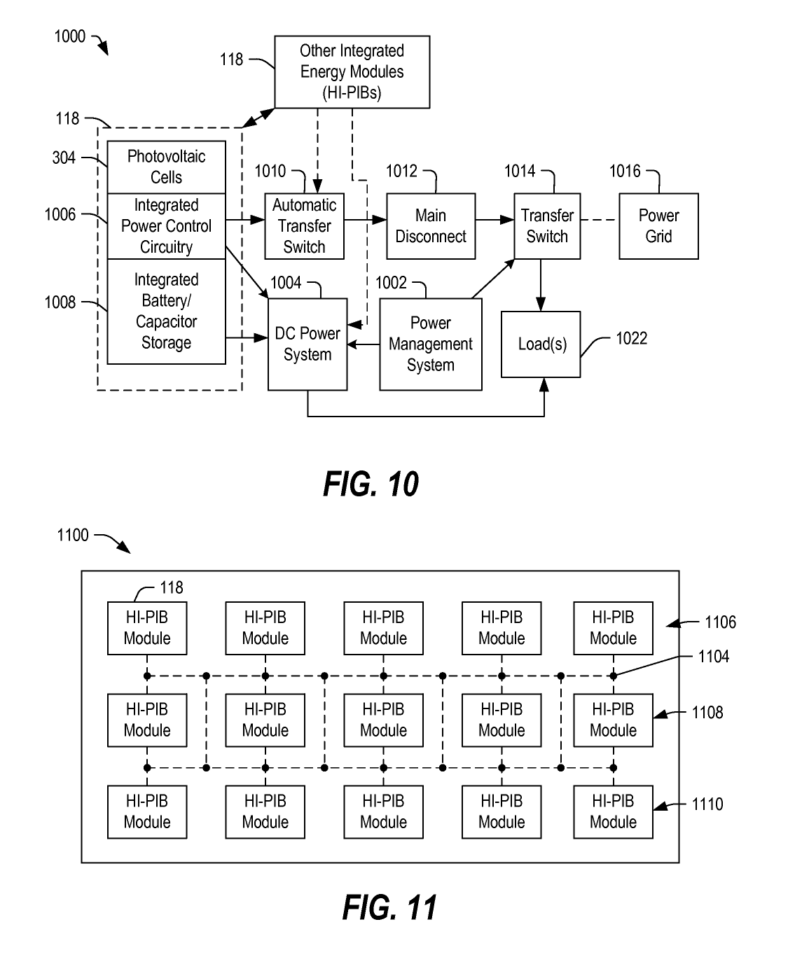

FIG. 10 is a block diagram of a solar power system including multiple integrated energy modules according to an embodiment. The integrated energy module 118 includes one or more photovoltaic cells 304, integrated power control circuitry 1006 (including a self-organizing switch network), and integrated battery/capacitor storage 1008. The integrated energy module 118 may be coupled to one or more other integrated energy modules (highly integrated photovoltaic inverter battery module or HI-PIB module) 118. The integrated energy module 118 is coupled to an automatic transfer switch 1010 and to a DC power system 1004, which may include a high voltage charging system.

Automatic transfer switch 1010 may be coupled to the power grid 1016 through a main disconnect switch 1012 and a transfer switch 1014. Further, system 1000 may include a power management system 1002 coupled to transfer switch 1014 and to high DC power system 1004 to selectively control their operation. The power management system 1002 may be part of the power management system 110 in FIGS. 1 and 9.

Power management system 1002 may control DC power system 1004 to selectively couple to load 1022, for example, to charge the batteries of an electric vehicle or to supply DC power to one or more DC-powered devices. Further, power management system 1002 may control transfer switch 1014 to selectively transfer power to a load 1022, such as a home or office, or to power grid 1016.

In an embodiment, power management system 1002 may control transfer switch 1014 to receive power from the power grid 1016 and to provide the power to a charging system, such as DC power system 1004 (through a connection that is not shown) in the event that thee integrated battery/capacitor storage 1008 has insufficient stored power to complete a charging operation for an electric car. Alternatively, when integrated battery/capacitor storage 1008 is fully charged, power management system 1002 may direct any additional power produced by integrated energy modules 118 onto the power grid 1016 by controlling transfer switch 1014. Subsequently, upon detection of a load 1022 coupled to system 1000, power management system 1002 may control DC power system 1004 to deliver power to load 1022.

As adoption of electric car technologies becomes more widespread, charging stations may become more widely available. Since there are few such charging stations and since recharging takes more time than filling a gas tank, it would be beneficial if the charging station availability, including availability of sufficient charge to recharge the batteries, could be determined in advance of the user's arrival at the station.

FIG. 11 is a block diagram of a solar power system 1110 including integrated energy modules 118 that can be selectively interconnected according to an embodiment. The solar power system 110 includes three rows 1106, 1108, and 1110, and each row 1106, 1108, and 1110 includes five integrated energy modules 118. The integrated energy modules 118 are interconnected by a bus network structure, generally indicated at 1104. The PMAD DSCs within energy modules 118 control switches to dynamically self-organize the integrated energy modules 118 using the bus network structure 1104, making it possible for the integrated energy modules 118 to detect one another and to cooperate to store energy and to provide DC and AC outputs.

Each of the integrated energy modules 118 includes a housing and an input/output interface 1112, which may extend partially within and partially outside of the housing. In an example, the input/output interface 1112 may include a plurality of conductive ports or terminals that may interconnect (electrically) with corresponding conductive ports or terminals of an adjacent integrated energy module 118. In some embodiments, the input/output interface 1112 may cooperate with adjacent input/output interfaces to form the bus network structure 1104. In an embodiment, the input/output interfaces 1112 may include switches and interconnecting wire traces that may be configured by a controller, such as a PMAD DSC controller to dynamically interconnect the integrated energy module 118 to other integrated energy modules.

In an example, each integrated energy module 118 includes at least a portion of the bus network structure and includes communication control and switching capabilities to facilitate communication of power and/or data to selected ones of the integrated energy modules 118 within the array. In an embodiment, the plurality of integrated energy modules 118 may organize themselves in a master/slave configuration where one of the integrated energy modules 118 assumes a master role to exercise control over other integrated energy modules 118 (operating as slave modules) within solar power system 1110. In an example, power produced by a first integrated energy modules 118 may be converted into an AC signal that can be synchronized and combined with AC signals from others of the integrated energy modules 118 to produce an AC signal that can be provided to an AC output, such as AC output line 124 in FIG. 1. The synchronization timing of the integrated energy modules 118 may be provided by the PMAD DSC of the one acting as the master.

Further, in the event that one of the integrated energy modules 118 fails, the other integrated energy modules 118 may operate to reroute power and data around the failed module using the bus network structure 1104. Further, one of the integrated energy modules 118 may communicate the failure event to a remote system through network 122 using the communication device 120, thereby initiating a service call. Thus, the plurality of integrated energy modules 118 cooperate to provide a self-healing, self-aligning and self-organizing power generation system.

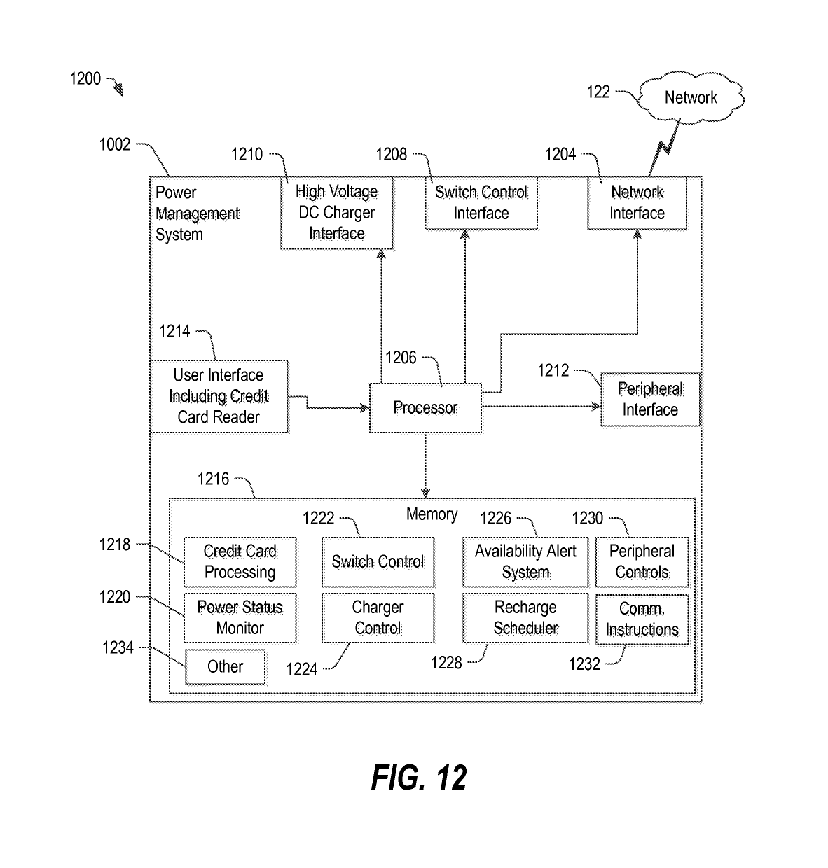

FIG. 12 is a block diagram of a system including a power management system 1002 (of FIG. 10) of a solar power system according to an embodiment. The power management system 1002 includes a network interface 1204 configured to communicate with a network 122. Network interface 1204 makes it possible for power management system 1002 to communicate its charge state and current use status to a remote system, such as a server, through network 122. Power management system 1002 further includes a processor 1206 coupled to network interface 1204, a switch control interface 1208, a high voltage DC charger interface 1210, a user interface 1214 (such as the user interface 110 in FIG. 1). In an embodiment, the user interface 1214 may include a credit card reader, a radio frequency identification (RFID) reader, a near field card (NFC) reader, or other identification reader. Power management system 1002 also includes a peripheral interface 1212, which may be coupled to one or more peripheral devices, such as lights, a fan, vending machines, and the like, to provide power and/or communication capabilities. Power management system 1002 further includes a memory 1216 coupled to processor 1206.

Memory 1216 is configured to store instructions that, when executed, cause processor 1206 to schedule, reserve, and process recharge operations. In the illustrated example, memory 1216 includes credit card processing instructions 1218 that, when executed, causes processor 1206 to receive credit or debit information from user interface 1214 and to process a charge via a charge processing system accessible through network 122.

Memory 1216 further includes a power status monitor 1220 that, when executed, causes processor 1206 to determine the charge status of the power storage batteries and/or the availability of power from the power grid. Memory 1216 also includes switch control instructions 1222 that, when executed, cause processor 1206 to control switches, such as switches discussed with respect to integrated circuitry 406 in FIG. 4 and transfer switches 1014 in FIG. 10, to selectively deliver power to a load. Memory 1216 also includes charger control instructions 1224 that, when executed, cause processor 1206 to selectively enable the charging system to deliver power to the load, such as an electric car 920 in FIG. 9. Memory 1216 further includes peripheral control instructions 1230 that, when executed, cause processor 1206 to control one or more peripheral devices, such as lights, a ceiling fan, and other peripheral elements (not shown), which may be mounted to the underside of the canopy, such as to the spine 116 or ribs 114 (in FIG. 1). Memory 1216 also includes other instructions 1232 that, when executed, cause processor 1206 to perform other functions, including upgrading other stored software modules as needed, monitoring external devices (such as soda machines or other machines to determine when they should be refilled, and so on).

Memory 1216 includes availability alert system instructions 1226 that, when executed, cause processor 1206 to check the power status of the power storage units to determine whether sufficient charge is available for charging a load (and optionally whether the charge is available for a fast, high-voltage charging operation or for a longer duration charge operation. Memory 1216 further includes communication instructions 1232 that, when executed, cause processor 1206 to communicate with a remote devices through the network 122. The communication instructions 1232 may include transceiver control instructions, formatting and communications protocol instructions, and other instructions including scheduling of communications. Further, availability alert system instructions 1226 cause processor 1206 to provide information to a remote server via network 122 indicating availability using the communication instructions 1232.

Electric cars may be provided with an on-board navigation system capable of interacting with the remote server to determine available charging stations and to receive directions to a selected charging station for recharge. In an embodiment, a driver may pre-pay for a charging station and reserve a spot, which reservation and payment may be communicated to power management system 1002 through network 122.

Memory 1216 may include recharge scheduler instructions that, when executed, cause processor 1206 to reserve the recharge slot for the driver. In an example, an indicator associated with recharge station may be changed (via peripheral control instructions 1230 and peripheral interface 1212) to indicate that the charge station has already been reserved. When the driver arrives, he or she may enter a code or otherwise interact with the user interface to log in to initiate the recharge operation, which causes processor 1206 to execute switch control instructions 1222 and/or charger control instructions 1224 to provide power to the load, such as the battery pack of an electric car.

It should be understood that the power management system 1002 is configurable to operate with any number of power sources, including a grid power source, a power generator (such as an integrated energy module 118), other power sources, or any combination thereof. In an embodiment, for the driver's comfort, a car port structure or canopy may be provided under which the driver may park his/her vehicle during the recharge operation. In an example, the canopy may be formed from a plurality of integrated energy modules 118, which may be coupled to a high-voltage, fast power charging system and to the power management system 1002 to provide a recharge station for electric cars. The integrated energy modules 118 provide low form factor because they can be integrated into the canopy of the car port, providing both power and shade for the user.

In an embodiment, a frame of the canopy is configured to secure a plurality of the integrated energy modules 118 (photovoltaic cells, bus network structure, control circuitry, batteries, power converters/inverters, and cooling systems), maximizing the parking area and securing the circuits and power storage above the ground.

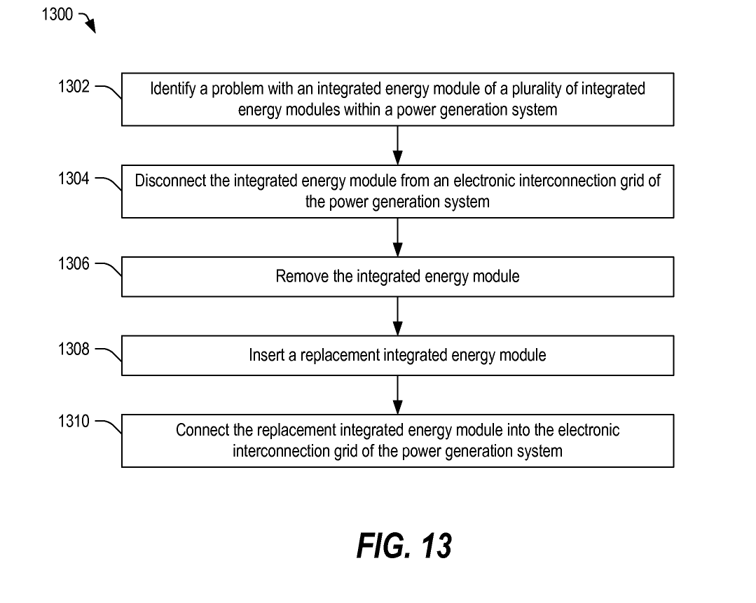

FIG. 13 is a flow diagram of a method 1300 of servicing an integrated energy module 118 according to an embodiment. At 1302, a problem with an integrated energy module of the plurality of integrated energy modules within a power generation system is identified. In an embodiment, the problem may be identified by one of the PMAD DSC controllers 738 and 748 and may be communicated to a remote system through network 122.

Advancing to 1304, the integrated energy module may be disconnected from an electronic interconnection grid of the power generation system. In addition to the PMAD DSC controller 812 altering interconnections of the interconnect network to decouple the failed integrated energy module, a service technician may arrive and disconnect the integrated energy module from the bus network structure. Continuing to 1306, a technician may remove the integrated energy module. Removing the integrated energy module may include lifting the integrated energy module out of the array. In an embodiment, the technician may grip an edge of a frame of the integrated energy module and lift it up, tilting the integrated energy module out of the array, and may then lift the entire module out.

Proceeding to 1308, the technician may insert a replacement integrated energy module into the place of the previously removed integrated energy module. In an embodiment, the technician may insert a first end into an open space within the array, align the end to abut an edge of the frame or to abut the edge of an adjacent energy module and then tilt the integrated energy module down and into the open space.

Continuing to 1310, the service technician may connect the replacement integrated energy module into the electronic interconnection grid of the power generation system. Once the replacement integrated energy module is in place and connected, the PMAD DSC controller 738 and 748 of the replacement integrated energy module is configured to communicate with other PMAD DSC controllers 738 and 748 of other integrated energy modules and to self-align to provide plug-and-play functionality.

Embodiments of integrated energy modules, systems, and methods are described above with respect to FIGS. 1-13. In accordance with various embodiments, the methods described herein may be implemented as one or more software programs running on a processor or controller. In accordance with another embodiment, the methods described herein may be implemented as one or more software programs running on a computing device, such as a personal computer. Dedicated hardware implementations including, but not limited to, application specific integrated circuits, programmable logic arrays, and other hardware devices can likewise be constructed to implement the methods described herein. Further, the methods described herein may be implemented as a computer readable storage medium or device including instructions that when executed cause a processor to perform the methods.

The illustrations, examples, and embodiments described herein are intended to provide a general understanding of the structure of various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above examples, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

Although the present invention has been described with reference to preferred embodiments, workers skilled in the art will recognize that changes may be made in form and detail without departing from the scope of the invention.

What is claimed is:

1. An integrated energy module comprising:
an array of photovoltaic cells;
a battery module;
an input/output interface; and
an integrated power control circuit to configure the input/output interface to dynamically couple to one or more other integrated energy modules of a solar array.

2. The integrated energy module of claim 1, further comprising a housing defining an enclosure sized to receive and secure the array of photovoltaic cells, the battery module, and the integrated power control circuit.

3. The integrated energy module of claim 1, further comprising a bidirectional DC-to-DC converter coupled between the battery module and the input/output interface.

4. The integrated energy module of claim 3, further comprising a bidirectional DC-to-AC inverter coupled between the bidirectional DC-to-DC converter and the input/output interface.

5. The integrated energy module of claim 1, wherein the integrated power control circuit further comprises a plurality of switches coupled to the array of photovoltaic cells and responsive to the integrated power control circuit to dynamically recover power from at least a portion of one of the photovoltaic cells of the array.

6. The integrated energy module of claim 1, wherein the integrated energy module further includes a conduit configured to circulate a coolant fluid around at least the battery module and the integrated power control circuit.

7. The integrated energy module of claim 1, wherein the integrated power control circuit comprises a peak power tracking and load balancing circuit coupled between the plurality of photovoltaic cells and the battery module.

8. The integrated energy module of claim 7, wherein the integrated power control circuit further comprises:
a battery charge/discharge circuit coupled between the load balancing circuit and the battery module;
a bidirectional DC-to-DC converter coupled to the battery charge/discharge circuit; and
a bidirectional AC-to-DC inverter coupled between the DC-to-DC converter and the output.

9. The integrated energy module of claim 8, wherein the integrated power control circuit is coupled to the array of photovoltaic cells, the peak power tracking and load balancing circuit, the battery charge/discharge circuit, the bidirectional DC-to-DC converter, and the bidirectional DC-to-AC inverter.

10. A power generation system comprising:
a solar array formed from a plurality of integrated energy modules, each of the plurality of integrated energy modules comprising:
a housing;
at least one photovoltaic cell within the housing;
a battery module within the housing;
an input/output interface at least partially within the housing; and
an integrated power control circuit within the housing, the integrated power control circuit to configure the input/output interface to dynamically interconnect the integrated energy module to one or more other integrated energy modules of the solar array.

11. The power generation system of claim 10, wherein:
the input/output interface includes a direct current (DC) input/output terminal; and
a bidirectional DC-to-DC converter within the housing and coupled between the battery module and the DC input/output terminal.

12. The power generation system of claim 10, wherein the integrated power control circuit further comprises a plurality of switches coupled to the array of photovoltaic cells and responsive to the integrated power control circuit to dynamically recover power from at least a portion of one of the photovoltaic cells of the array.

13. The power generation system of claim 10, wherein the solar array is secured within a car port including:
a canopy configured to secure the solar array;
a pillar including a first end configured to be secured to the ground and including a second end; and
a trunion configured to couple the frame to the pillar and configurable to adjust an orientation of the canopy on at least two axes.

14. The power generation system of claim 13, wherein the pillar comprises at least one conduit extending from the first end to the second end and configured to transport a coolant fluid from a subterranean geothermal heat exchanger to each of the integrated energy modules of the solar array.

15. The power generation system of claim 10, further comprising a DC power system coupled to the battery and configured to selectively provide a DC charge to a load.

16. The power generation system of claim 15, further comprising a power management system coupled to the DC power system, the power management system comprising:
a user interface;
a communication interface configured to communicate data to and from a remote device through a network; and
a control system configured to selectively enable the DC power system to provide the DC charge.

17. An integrated energy module comprising:
a housing;
an array of photovoltaic cells within the housing;
a battery module within the housing; and
an integrated power control circuit within the housing and configured to selectively activate one or more switches to recover energy from at least a portion of one of the photovoltaic cells of the array.

18. The integrated energy module of claim 17, further comprising:
a battery charge/discharge circuit coupled to the battery module; and
a peak power tracking and load balancing circuit coupled between the battery charge/discharge circuit and the array of photovoltaic cells.

19. The integrated energy module of claim 18, further comprising:
an input/output interface;
a bidirectional DC-to-DC converter coupled to the battery charge/discharge circuit; and
a bi-directional DC-to-AC inverter coupled between the bidirectional DC-to-DC converter and the input/output interface.

20. The integrated energy module of claim 17 further including a plurality of switches coupled to the array of photovoltaic cells and responsive to the integrated power control circuit to dynamically recover power from at least a portion of one of the photovoltaic cells of the array.
